(19) United States
(12) Patent Application Publication
(10) Pub. No.: US 2010/0023558 A1
(43) Pub. Date: Jan. 28, 2010

(54) METHOD FOR MANAGING OBJECTS ACCESSIBLE TO USERS AND COMPUTER DEVICE INVOLVED FOR IMPLEMENTATION OF THE METHOD

(76) Inventors: Jean-Patrice Glafkides, Fontenay Sous Bois (FR); Jeremy Grinbaum, Saint-Maur (FR)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 12/362,577

(22) Filed: Jan. 30, 2009

(30) Foreign Application Priority Data
Jul. 22, 2008 (FR) 0804166

(51) Int. Cl. G06F 17/30

(52) U.S. Cl. 707/200; 707/E17.009

(57) ABSTRACT

This method for managing objects accessible to users comprises the following steps:
assignment of at least one descriptive marker (T′1, T′2,b . . . ) for each object (Xi°),
assignment of at least one marker of right for each object in order to define access of the said objects, characterized in that it comprises, in addition, the steps:
assignment of markers (T1, T2, . . . ) for each user (USRi),
accessibility of the object granted to the user on the basis of a concordance between the said markers of the object and of the user.

The present invention relates to a method for managing objects accessible to users comprising at least the following step:

assignment of at least one descriptive marker for each object.

The present invention relates to a computer device for implementation of the method.

Such methods and devices are envisioned in United States of America Patent U.S. Pat. No. 6,810,394.

The means proposed in this patent envision the management of documents especially as concerns their classification and providing facilities for recovering them. However, they are insufficient for management in enterprises in which, among other things, account must be taken of users who do not want to be swamped by too much information, as well as of the selection of documents accessible to a given category of users.

The invention therefore proposes a method that permits effective management of documents and, more generally, of all computer objects (programs, services, user profiles, etc.) which the user may call for.

According to the invention, the method mentioned at the beginning is remarkable in that it comprises, in addition, the steps:

assignment of markers for each user,

accessibility of the object granted to the user on the basis of a concordance between said markers of the object and of the user.

The idea of the invention rests on the idea of managing the system by means of markers assigned to all objects and also to users and, starting on this basis, determination may be made of the rights of access to be granted to each user with whom a profile which itself is considered as an object is associated.

An important characteristic of the invention according to which a method of the type mentioned above, used for performing searches on the basis of markers comprising a step of visualization of markers defined starting from an initial marker, remarkable in that it comprises a step of storage of pertinence for storing a link corresponding to the initial marker and a marker held by the user and for increasing the pertinence of this link if the latter is already stored in view of establishing a list of markers classified by pertinence, brings the important advantage that accesses to objects are automatically updated and lends better effectiveness to searches that the user makes, since the links having great pertinence will be those most used.

The following description, together with the accompanying drawings, all given by way of non-limitative example, will clearly explain how the invention can be implemented. In the drawings:

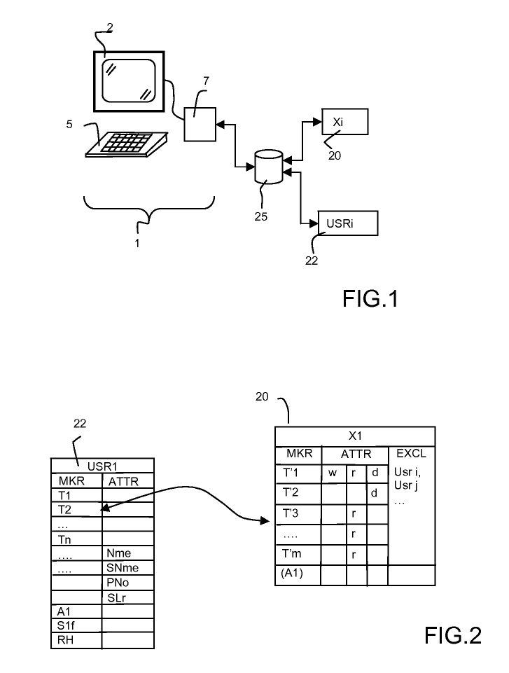

FIG. 1 shows a device involved for implementation of the method according to the invention,

FIG. 2 shows the implementation of markers assigned to users and to objects,

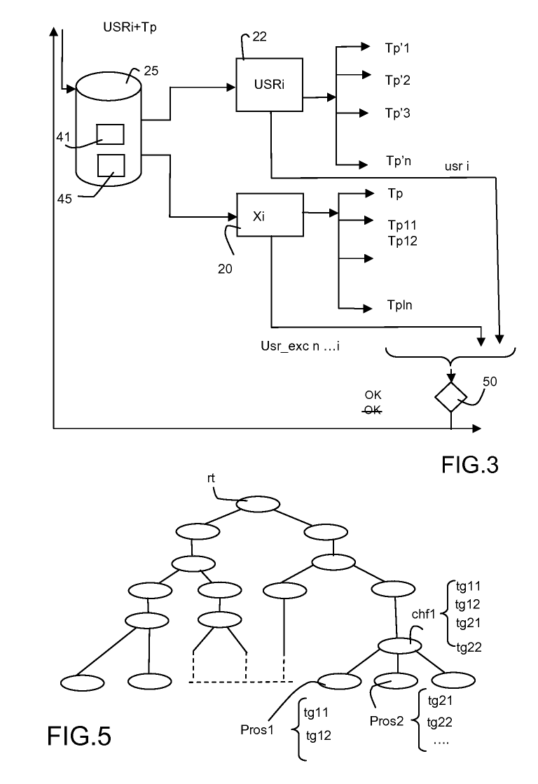

FIG. 3 explains the operation of the marker motor,

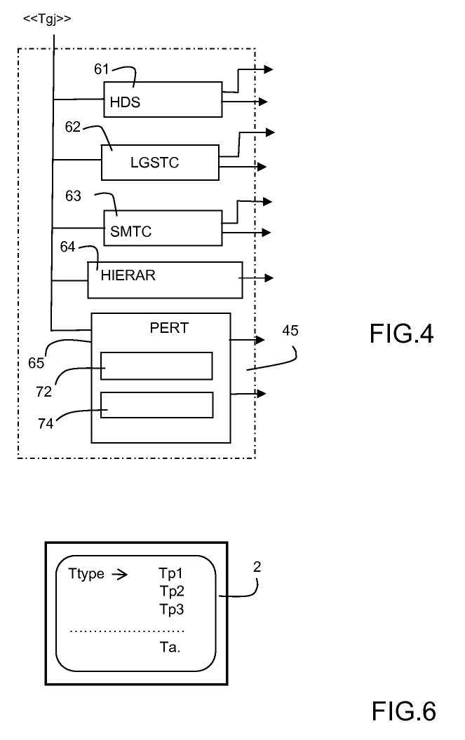

FIG. 4 shows the various types of links available,

FIG. 5 shows the manner in which hierarchical links are created,

FIG. 6 shows the order of visualization of markers, notably of markers of pertinence.

The device shown in FIG. 1, forming part of an enterprise network, is made up starting from a computer terminal 1 such as a PC. It is composed essentially of a screen 2 for visualizing information, a keyboard 5 for inputting information and a computer set 7 bringing together the usual elements of a PC. It is from this terminal that the user is able to access a variety of information that he has to process in his enterprise. This information is grouped in objects and is made up, for example, of text documents, images, sounds, etc., as well as of applications. These objects are contained in a variety of servers referenced without distinction by a database 20. An important object concerns the users. It goes without saying that not all users have access to all information. To manage these accesses, use is made of a user database 22, which contains a directory of all users having access to the enterprise network. This user base 22 makes it possible to grant each user rights of access to the database 20 and also to information concerning the users contained in this same user database 22.

To manage accesses and, thus, also searches concerning these objects, the invention proposes associating markers (called “tags” in the Anglo-Saxon literature) with all these objects. A device 25, called marker motor, is assigned solely to the processing of these markers, within the scope of the invention.

According to the invention, markers are assigned to each of the objects, including users. In FIG. 2 are shown two tables relative to the bases 20 and 22, respectively. Various markers T1, T2, . . . Tn are assigned to a user USR1 and correspond to his/her areas of interest. Attributes (column ATTR) are also provided. These various attributes for users may be their last name “Nme,” first name “SNme,” telephone number “Pno,” salary “Slr,” etc. Accesses to these attributes for consultations and modifications are also managed by markers. To be noted are:

marker “A1,” which allows everyone to see the civil status of the user assigned this marker;

marker “Slf,” which gives the user the right to modify his/her telephone number, for example;

marker “RH,” which gives the user to whom it is assigned the right to modify all attributes including salary, except for the one concerning his/her own salary, where modification of the salary is blocked.

Similarly, the column MKR shows various markers T′1, T′2, . . . T′n, which are assigned to an object X1. Besides these markers, the object X1 is equipped with attributes (column ATTR) defining the rights of access relative to each of the markers that are assigned to it. These rights may be those of reading: “r,” writing: “w” and deletion: “d” of data forming part of the object. It is of course possible to define other categories of rights as a function of the objects to which they are attributed. Defined in addition are exclusions (column EXCL), i.e., the name of various users “usr i,” “usr j,” etc., who must be rejected when they attempt to access the object. To summarize, the user USR1 will not have access to the object X1 unless there is a correspondence between at least one of his markers and at least one marker of the object X1 corresponding to the action that he/she wishes to perform. For example, if T2 and T′3 are identical, then the user USR1 will have access to the object in question, in reading only, as indicated in FIG. 2. This will be possible on condition, however, that his/her name is not mentioned in the column EXCL. It is to be noted that a marker “A1” may be assigned to objects. This marker then gives access to the object to all users.

Access to Objects

FIG. 3 shows the functionalities of the marker motor 25. This motor receives all queries concerning these markers. It makes it possible to access, via the database 22, the markers assigned to users, which gives a list of markers Tp′1, . . . , Tp′n. When the user types a word that defines a marker, it is searched in a marker table 41 containing all the markers already recorded. If this word is not contained in the table 41, the user is invited to create it. Starting from a marker, a link management system 45, the structure of which will be explained below, is called up. This link management system 45 then supplies a list of markers comprising the initial markers followed by markers supplied by the link management system 45. All of these latter markers will make it possible to access the objects of the database 20 having these marker names. An access control means 50 compares, on the one hand, the markers of the user with those of the objects and, on the other hand, whether or not the user is excluded from access of the object in question. If the tests are positive, then the user has access to this object.

Organization of Links

FIG. 4 shows the organization of the link management system 45. A table called manual or authoritarian link table 61 is seen. These links are established, in an authoritarian fashion, by the user himself when desired. A table of links, called linguistic link table 62, consists in supplying markers in languages other than that of an initial marker “Tgi.” A table 63 of semantic links consists in supplying markers whose meaning evokes the initial marker. For example, a marker “pigeon” may supply “wing” as another marker. Another type of link is the hierarchical link, defined by the table 64. By a tree structure, this hierarchical link links the users of an enterprise with each other. This hierarchical organization is shown in FIG. 5, and lastly, a table 65 of links of pertinence defining their pertinence [is shown].

Hierarchical Links

Users are arranged according to a tree with a root “rt” and all users have access to the objects of users situated below in their branch. It follows from this that the user at the root “rt” has access to all the objects.

Hence, the user “Pros1,” who is at the bottom of the tree, has various markers “tg11,” “tg12,” etc. that are associated with him/her. The user situated at the same hierarchical level, “Pros2,” may have markers “tg21,” “tg2,2” [sic] unlike those of “Pros1.” Their hierarchical superior “chf1” will then inherit their markers, so that he will have access to all the objects of the users “Pros1,” “Pros2,” i.e., to the objects having the markers tg1,1, tg1,2, . . . tg2,1, tg2,2 . . . .

Object Search—Updating of Links

The method of the invention is provided for supplying lists of objects established on criteria selected by the user and established on the basis of markers. To show a list of objects according to their pertinence, relations of pertinence between the markers have been established.

To that end, the link management system 45 supplies an evolutionary manner of making searches on objects contained in the base 20. For this, the user, as has been seen, uses markers. For an initial marker given by the user, the link management system 45 will now supply a list of other markers. The other markers are presented to him according to a degree of pertinence established by means of a weighting memory 72, which stores the various links with, in regard to each of them, their degree of pertinence. The marker held for continuing the search and the initial marker will constitute a link which will be stored in the weighting memory 72, either for a first storage or for an increase in the degree of pertinence. A deleting system 74 permits updating of the pertinences acquired.

Thus, for example, a user searches documents relating to “duck,” the fowl. The link management system may supply him/her with markers other than “duck” and, among others, “pigeon.” If the user then directs his search starting from “pigeon,” the weighting system attributes a given degree of pertinence to the “duck”-“pigeon” link. This link will then be stored in the link memory 72 of the marker manager 45 with a given degree of pertinence. If the marker “pigeon” is again used following a query made on the marker “duck,” the link will be increased by the number of degrees of pertinence.

Automatically, for example each week, systematically, the degrees of pertinence are reduced by a given value. When the degree of pertinence falls to zero, the link is deleted from the memory 72 and the marker involved in this link will no longer have priority for appearing to the user.

FIG. 6 shows the visualization of markers on the screen 2. Thus, if the user types a marker Ttype, the marker Tp1 having the weighting indicating the highest pertinence will appear first, and so on in succession for the markers having lower and lower weightings. Then, links supplied by the various link tables 61, 62, 63 and 64 will appear. If the user takes advantage of one of the proposed markers, the coefficient of pertinence of the link between the two markers will be increased and placed in memory. It is evident that other means of perception of pertinent links may be envisaged, without thereby exceeding the scope of the invention.

Problems of conflicts of rights may also arise, so the invention proposes the following strategy:

In the notion of right, the priorities are the following, if a marker is found in several categories: Priority is given:

1) to proprietors (PO)

2) to exclusions

3) to other rights.

Thus, by default, there is no right except (PO) to all rights on the object.
a) Exclusion+right (rw)→set of rights—exclusion

If one is in the list of exclusions, one loses the right attached to the exclusion.
b) Exclusion+PO→PO

If one is proprietor of the object and is excluded, then one keeps the rights due to proprietors.
c) PO+rights→Union (right and PO)

The proprietor has his/her rights plus those defined by the rights
d) PO+rights+exclusion→Union ((set of rights—exclusion) and PO)

If one is in the list of exclusions, one loses the right attached by the exclusion, and one gains the rights of the PO if one is the proprietor.

1. Method for managing objects accessible to users comprising the following steps:
assignment of at least one descriptive marker for each object, characterized in that it comprises, in addition, the steps:
assignment of markers for each user,
accessibility of the object granted to the user on the basis of a concordance between the said markers of the object and of the user.

2. Method according to claim 1, characterized in that it comprises a step of assigning an attribute of right for each object in order to define access to the said objects.

3. Method according to claim 2, characterized in that it comprises steps for creating links between the markers.

4. Method according to claim 3, characterized in that there is provided a step of authoritarian relation for causing a marker to correspond with at least one other marker, performed by the user.

5. Method according to claim 1, characterized in that it comprises a step of linguistic relation for linking a marker of a given language with its equivalent in another language.

6. Method according to any of claim 1, characterized in that it comprises a step of tree-structure relation of root-branch type assigned notably to users for giving access of objects accessible to a user to other users situated closer to the root of the tree.

7. Method according to any of claim 6, used for making searches on the basis of markers comprising a step of perception of markers defined starting from an initial marker, characterized in that it comprises a step of storage of pertinence for storing a link corresponding to the initial marker and a marker held by the user and for increasing the pertinence of this link if the latter is already stored in view of establishing a list of markers classified by pertinence.

8. Method according to claim 7, characterized in that it comprises a deleting step for decreasing pertinence as a function of time.

9. Method according to claim 1, characterized in that attributes (ATTR-22) are assigned to users and in that their modifications are governed by markers.

10. A computer device for implementing a method of managing objects accessible to users, comprising a PC set equipped with means for connection to databases relating to objects and to users, an access control means for comparing the markers issuing from the objects and users concerned in view of granting access to objects in case of concordance of said markers unless an exclusion of the user is recorded in the object requested.
